(19) United States
(12) Patent Application Publication
(10) Pub. No.: US 2004/0162936 A1
(43) Pub. Date: Aug. 19, 2004

(54) Material control system

(75) Inventors: Akiko Hisasue, Tokyo (JP); Junji Tateishi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Renesas Technology Corp., Tokyo (JP)

(21) Appl. No.: 10/611,865

(22) Filed: Jul. 3, 2003

(30) Foreign Application Priority Data
Feb. 14, 2003 (JP) 2003-036935

(51) Int. Cl. G06F 13/28

(52) U.S. Cl. 711/108

(57) ABSTRACT

A material control system which provides for centralized control of a stock and an order so as to keep an appropriate control of materials in stock without differentiating a material which requires a regenerating process and a material which does not require a regenerating process. The material control system includes a master table storing information for controlling each of materials. The information is provided in an entry field of a regeneration control flag (104) indicating whether or not each of materials to be used in a manufacturing apparatus is regeneratable and an entry field of a regeneration order control flag (201) indicating whether or not a registered contractor is a seller or a regeneration contractor. The material control system further includes an order control section for making a purchase order for the materials and an order for a regenerating process, using the regeneration order control flag (201), and a stock control section for controlling a stock of the materials. The order control section and the stock control section are controlled in a centralized manner.

### BACKGROUND OF THE INVENTION

1. Field of the Invention

The present invention relates to control of materials used in a manufacturing apparatus, and more particularly to control of materials which are used in an apparatus for manufacturing a semiconductor device or the like and subjected to a regenerating process.

2. Description of the Background Art

Conventional control of materials carried out in manufacture of semiconductor devices includes only control of supply and/or release of materials such that a new material is supplied when a material is consumed. Also, conventional control of an order for materials has been simply to purchase new materials when a stock is exhausted. Such conventional ways for controlling materials have been employed in manufacture of not only semiconductor devices but also other various products, of course. It is noted that the term “material” used hereinbefore and hereinafter in the present specification will mean raw materials directly employed in products to be manufactured, components employed in an apparatus for manufacturing products, materials consumed during manufacture of products, and the like.

The conventional ways of controlling materials including recycled items are disclosed in Japanese Patent Application Laid-Open Nos. 2002-311211 and 2000-181958 (hereinafter, abbreviated to “JP '311211” and “JP '181958, respectively). In brief, according to JP '311211, control of purchase and stock of materials, as well as arrangement of a use schedule of materials, are automatically carried out while differentiating repeatedly-usable materials and consumable materials from each other. More specifically, JP '311211 discloses a system formed of: means for entering an order; means for subtracting a quantity of reusable materials out of a total quantity of materials on order, from a quantity of corresponding materials in stock, and adding a quantity of reusable materials which have been used and returned, to a quantity of corresponding materials in stock; and means for subtracting a quantity of non-reusable materials out of the total quantity of materials on order, from a quantity of corresponding materials in stock.

According to JP '181958, which relates to a recycling system, a recycling process including all steps to be performed from supply of materials to final disposal is comprehensively controlled. More specifically, JP '181958 discloses a system formed of: a memory for storing information about all of reusable products, components and raw materials, irrespective of whether they have been disposed of, or are currently on the market, as recycle information; a virtually designing part for predicting a time when the reusable products, components or raw materials are recovered as recyclable products, components or raw materials, and predicting a quantity of the recyclable products, components or raw materials, based on the recycle information stored in the memory; and a scheduling part for arranging a production schedule of recycled items formed using the reusable products, components or raw materials, based on the time and the quantity as predicted.

However, during manufacture of semiconductor devices, for example, a surface of a quartz bulb used in a diffusion furnace, an electrode of an etching apparatus, a vacuum pump or the like, is likely to suffer abrasion or degradation after it is used for a certain period of time, and thus require a regenerating process. Such a material which requires a regenerating process could not be appropriately controlled by the conventional controlling ways in which supply and/or release of materials is controlled or an order for new materials is made only when a stock of corresponding materials is exhausted as described above. It is additionally noted that the “regenerating process” (or “regeneration”) is a process of treating a surface of a material so as to expose a new surface of the material by using chemicals, or by physically shaving the material, for example.

As a regenerating process on materials is a process of replacing an internal substance of a material or a process of shaving a surface of a material, a unit price to pay for one same kind of material differs between an order for a regenerating process and a purchase order. Such difference in unit price could not be controlled by the conventional controlling ways, according to which the same unit price for both a purchase order and an order for a regenerating process has been paid to a single outside contractor. Moreover, a seller and an outside contractor who undertakes a regenerating process for one same kind of material are not always the same. Rather, an order for a regenerating process is probably given to an outside contractor who specializes in a regenerating process. Also in such a situation, sellers and contractors for a regenerating process could not be controlled in a centralized manner by the conventional controlling ways, to fail to achieve appropriate control.

The conventional controlling ways disclosed in JP '311211 and JP '181958 include control of a recycled item. A recycled item can be regarded as being analogous to a material which requires a regenerating process in that it can be repeatedly used. However, once a recycled item is assembled into a product, no control is needed until disposal thereof. In contrast thereto, in dealing with a material which requires a regenerating process, control of an order for a regenerating process, for example, is continuously needed so far as manufacture of products to be formed using the material is conducted. Further, to allow for an order for a regenerating process, also outside contractors who specialize in a regenerating process and do not sell materials should be controlled. For these reasons, control of a recycled item and control of a material which requires a regenerating process are non-analogous to each other. Accordingly, the conventional controlling ways disclosed in JP '311211 and JP '181958 could not be applied to a material which requires a regenerating process.

### SUMMARY OF THE INVENTION

It is an object of the present invention to provide a material control system which provides for centralized control of a stock and an order so as to keep an appropriate quantity of materials in stock, without differentiating a material which requires a regenerating process and a material which does not require a regenerating process.

According to the present invention, a material control includes a master table, an order control section and a stock control section. The master table includes an entry field of a regeneration control flag indicating whether or not each of materials to be used in a manufacturing apparatus is regeneratable and an entry field of a regeneration order control flag indicating whether a registered contractor is a seller or a regeneration contractor. The master table stores control information for each of the materials. The order control section controls a purchase order for, and an order for a regenerating process on, regeneratable materials out of the materials, using the regeneration order control flag. The stock control section controls a stock of the materials. The order control section and the stock control section are controlled in a centralized manner.

The material control system provides for centralized control of a stock and an order so as to keep an appropriate quantity of materials in stock without differentiating a material which requires a regenerating process and a material which does not require a regenerating process. In particular, the material control system produces an advantage of carrying out a procedure for releasing a material to be regenerated in controlling an order.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates a material master table of a material control system according to a first preferred embodiment of the present invention.

FIG. 2 illustrates a contractor master table of the material control system according to the first preferred embodiment of the present invention.

FIG. 3 is a flow chart illustrating operations of the material control system according to the first preferred embodiment of the present invention.

FIG. 4 illustrates a stock table of the material control system according to the first preferred embodiment of the present invention.

FIG. 5 is another flow chart illustrating the operations of the material control system according to the first preferred embodiment of the present invention.

FIG. 6 illustrates a material master table of a material control system according to a second preferred embodiment of the present invention.

FIG. 7 is a flow chart illustrating operations of the material control system according to the second preferred embodiment of the present invention.

FIG. 8 illustrates a stock table of the material control system according to the second preferred embodiment of the present invention.

FIG. 9 illustrates a regeneration control table of the material control system according to the second preferred embodiment of the present invention.

FIG. 10 illustrates a use display of the material control system according to the second preferred embodiment of the present invention.

FIG. 11 illustrates a storage display of the material control system according to the second preferred embodiment of the present invention.

FIG. 12 is another flow chart illustrating the operations of the material control system according to the second preferred embodiment of the present invention.

FIG. 13 illustrates a material master table of a material control system according to a third preferred embodiment of the present invention.

FIG. 14 is a flow chart illustrating operations of the material control system according to the third preferred embodiment of the present invention.

FIG. 15 is a regeneration control table of the material control system according to the third preferred embodiment of the present invention.

FIG. 16 is another flow chart illustrating the operations of the material control system according to the third preferred embodiment of the present invention.

### DESCRIPTION OF THE PREFERRED EMBODIMENTS

Preferred Embodiments

Below, preferred embodiments of the present invention will be described in detail, with reference to accompanying drawings.

First Preferred Embodiment

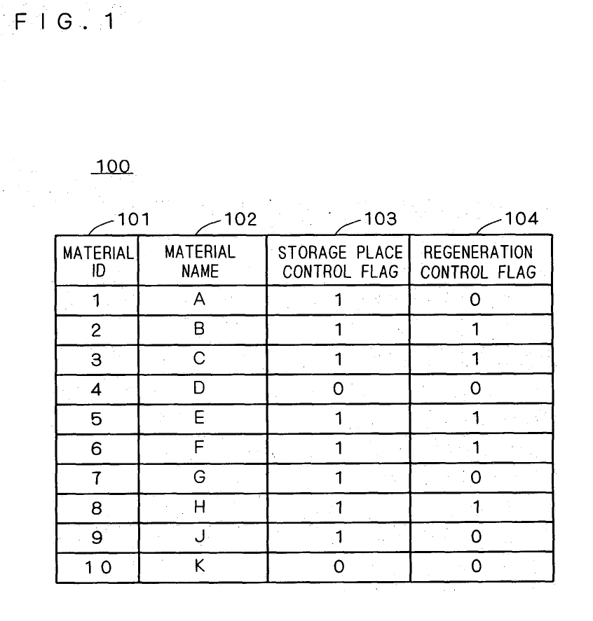

A material control system according to a first preferred embodiment provides for centralized control of a stock and an order on a manufacturing line for semiconductor devices or the like. The material control system includes a master table storing information for controlling (control information) materials. FIG. 1 shows one example of a part of the master table of the material control system according to the first preferred embodiment. The part of the master table as illustrated in FIG. 1 stores control information provided in respective entry fields of a material ID 101, a material name 102, a storage place control flag 103 and a regeneration control flag 104. Below, the part of the master table as illustrated in FIG. 1 will be referred to as a “material master table 100”.

The material ID 101 is an identification number assigned to each kind of material. That is, the same material ID is assigned to materials of the same kind. The material master table 100 is associated with another master table by the field of the material ID 101 which is included in both the master tables. The material name 102 is a name of a kind of a material. The storage place control flag 103 is a flag indicating whether or not a storage place where a material is stored is under control. The regeneration control flag 104 is a flag indicating whether or not a material is regeneratable. In the example of the material master table 100 of FIG. 1, when a flag is “0”, it indicates “OFF”, while when a flag is “1”, it indicates “ON”.

The example of the material master table 100 in FIG. 1 includes information about ten different kinds of materials. “1” through “10” for the respective kinds of materials are shown in the field of the material ID 101, and “A” through “K” for the respective kinds of materials are shown in the field of the material name 102. In the example of FIG. 1, it is appreciated from the storage place control flag 103 that storage places of materials of the kinds “A”, “B”, “C”, “E”, “F”, “G”, “H” and “J” are under control. Further, it is appreciated from the regeneration control flag 104 that materials of the kinds “B”, “C”, “E”, “F” and “H” are regeneratable.

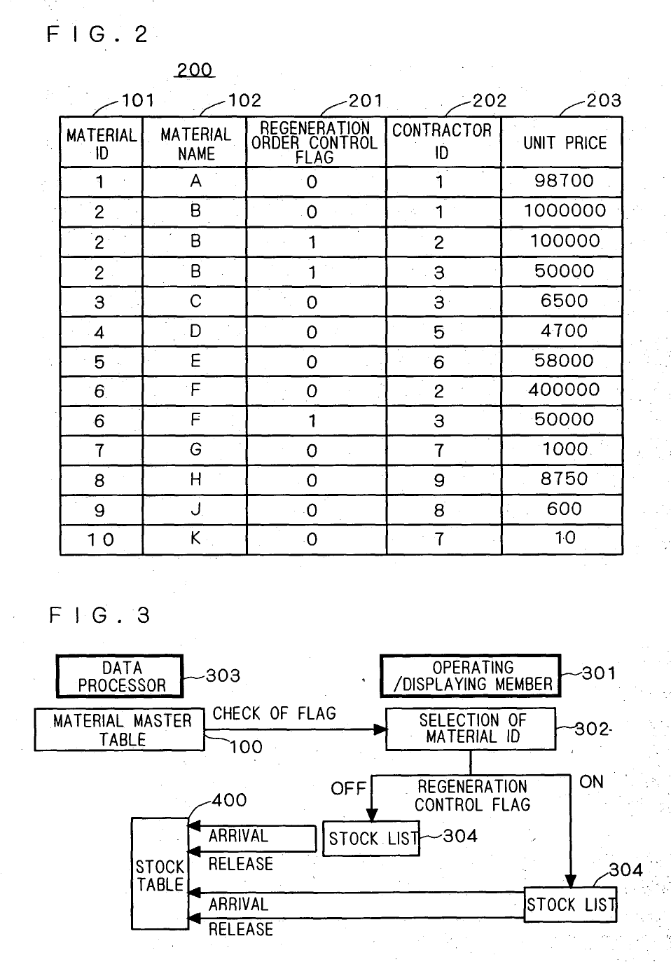

FIG. 2 shows one example of another part of the master table of the material control system according to the first preferred embodiment. The part of the master table illustrated in FIG. 2 is provided separately from the material master table 100, and is associated with the material master table 100 by the field of the material ID 101. The part of the master table as illustrated in FIG. 2 includes control information provided in respective entry fields of the material ID 101, the material name 102, a regeneration order control flag 201, a contractor ID 202 and a unit price 203. Below, the part of the master table illustrated in FIG. 2 will be referred to as a “contractor master table 200”.

The regeneration order control flag 201 is a flag indicating whether a registered contractor is a contractor receiving a purchase order (i.e., a seller) or a contractor receiving an order for a regenerating process (hereinafter, referred to as a “regeneration contractor”). In the example of FIG. 2, when the regeneration order control flag 201 is “0”, it indicates that a registered contractor is a seller, while when the regeneration order control flag 201 is “1”, it indicates that a registered contractor is a regeneration contractor. The contractor ID 202 is an identification number assigned to each registered contractor including sellers and regeneration contractors. In the example of FIG. 2, it is appreciated from the regeneration order control flag 201 that a seller and a regeneration contractor who are different from each other are registered for each of the material kinds “B” and “F”. With respect to the material kind “B”, a contractor having a contactor ID “1” is registered as a seller, and contractors having contractor IDs “2” and “3” are registered as regeneration contractors. With respect to the material kind “F”, a contractor having a contractor ID “2” is registered as a seller, and a contractor having a contractor ID “3” is registered as a regeneration contractor.

FIG. 3 is a part of a flow chart illustrating operations of the material control system according to the first preferred embodiment. The part of the flow chart of FIG. 3 is directed to operations of a stock control section of the material control system. First, upon selection 302 of one material ID which is carried by an operating/displaying member 301, a data processor 303 consults the material master table 100 to check the regeneration control flag 104 for the selected material ID. For example, referring to FIGS. 1 and 2, when the material ID “1” in the field of the material ID 101 is selected, it is determined that a material of the kind having the material ID “1” is not regeneratable, from the regeneration control flag 104 therefor which is “OFF”, as a result of consultation of the material master table 100. Also, when the material ID “2” in the field of the material ID 101 is selected, it is determined that a material of the kind having the material ID “2” is regeneratable, from the regeneration control flag 104 therefor which is “ON”, in the same manner.

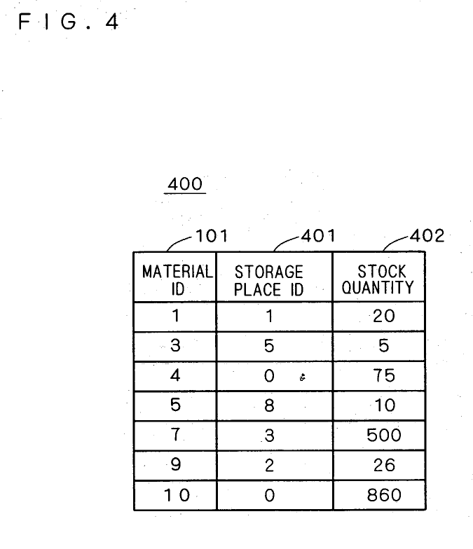

Next, after the check of the regeneration control flag 104 for the selected material ID is completed, a list 304 of materials in stock (not shown, hereinafter, referred to as a “stock list 304”) is displayed. Then, the stock list 304 is consulted, to control supply and/or release of materials of the kind having the selected material ID. Data for controlling supply and/or release is stored in a stock table 400. FIG. 4 shows one example of the stock table 400 according to the first preferred embodiment. The stock table 400 stores information provided in respective entry fields of the material ID 101, a storage place ID 401 and a stock quantity (a quantity of materials in stock) 402. In the example of FIG. 4, with respect to the material kind having the material ID “1”, twenty pieces are in stock at a storage place “1”. Further, with respect the material kind having the material ID “4”, seventy-five pieces are in stock. The storage place ID 401 for the material kind having the material ID “4” is displayed as “0”, because a storage place for the material kind having the material ID “4” is out of control. In such a situation, the storage place control flag 103 for the material ID “4” should be “OFF”.

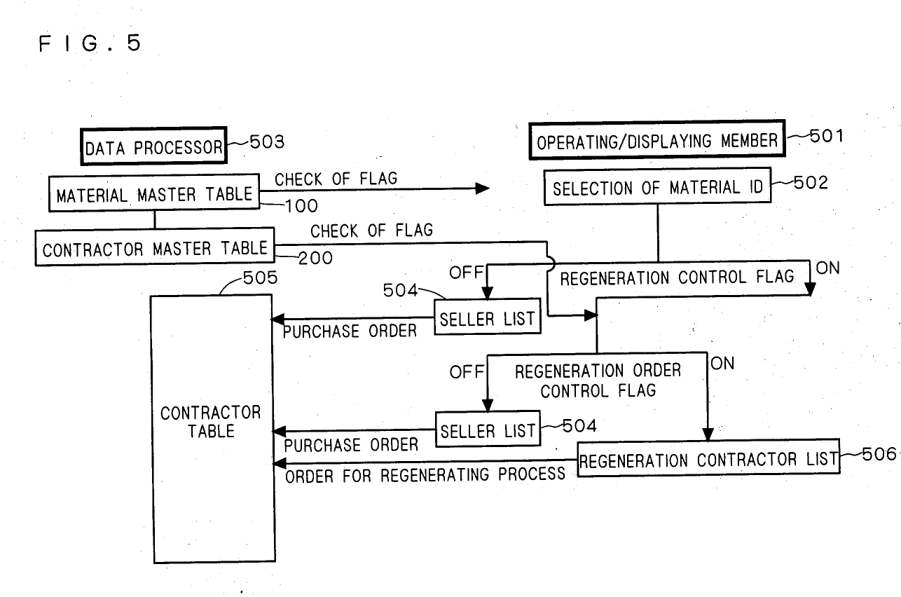

FIG. 5 is another part of the flow chart illustrating the operations of the material control system according to the first preferred embodiment. The part of the flow chart of FIG. 5 is directed to operations of an order control section of the material control system. First, upon selection 502 of one material ID 101 which is carried by an operating/displaying member 501, a data processor 503 consults the material master table 100 to check the regeneration control flag 104 for the selected material ID. If the regeneration control flag 104 for the selected material ID is “OFF”, a list 504 of registered sellers (not shown, hereinafter, referred to as a “seller list 504”) is displayed. One seller in the seller list 504 is selected, and then a purchase order for materials of the kind having the selected material ID is given to one of contractors stored in a contractor table 505 (not shown), who corresponds to the selected sellers in the seller list 504. To this end, the contractor table 505, which stores information about all registered contractors including sellers and contractors to undertake a regenerating process, is consulted for information about the selected seller, using the contractor ID 202 stored in the contractor master table 200. For example, referring to FIGS. 1 and 2, in making a purchase order for materials of the kind “A” having the material ID “1”, a contractor specified as a suitable contractor having a contractor ID “1” is contractor master table 200 and information about the contractor having the contactor ID “1” is retrieved from the contractor table 505, to thus make a purchase order for the materials of the kind “A” having the material ID “1”, at a unit price of “98,700”.

On the other hand, if the regeneration control flag 104 for the selected material ID is “ON”, the data processor 503 further consults the contractor master table 200 to check the regeneration order control flag 201 for the selected material ID. If “OFF” is displayed as the regeneration order control flag 201 for the selected material ID, the seller list 504 is displayed. One seller in the seller list 504 is selected, and then a purchase order for materials of the kind having the selected material ID is given to one of contractors stored in the contractor table 505, who corresponds to the selected seller in the seller list 504. To this end, the contractor table 505 is consulted for information about the selected seller using the contractor ID 202 stored in the contractor master table 200. If “ON” is displayed as the regeneration order control flag 201 for the selected material ID, a list 506 of registered regeneration contractors (not shown, hereinafter, referred to as a “regeneration contractor list 506”) is displayed. One regeneration contractor in the regeneration contractor list 506 is selected, to make an order for a regenerating process on materials having the selected material ID to one of the contractors stored in the contractor table 505, who corresponds to the selected regeneration contractor in the regeneration contractor list 506. To this end, the contractor table 505 is consulted for information about the selected regeneration contractor using the contractor ID 202 stored in the contractor master table 200.

For example, referring to FIGS. 1 and 2, in a case where the selected material ID is the material ID “2” of which kind is “B”, “ON” is displayed as the regeneration control flag 104 for the material kind “B” in the material master table 100. Then, if “OFF” is displayed as the regeneration order control flag 201 for the material kind “B”, the seller list 504 is displayed. In this case, a contractor having a contractor ID “1” is displayed as a suitable contractor, together with its unit price “100,000”. If “ON” is displayed as the regeneration order control flag 201 for the material kind “B”, the regeneration contractor list 506 is displayed. In this case, a contractor having a contractor ID “2” and a contractor having a contractor ID “3” are displayed as suitable contractors, together with their respective unit prices “100,000” and “50,000”. To make a purchase order for materials of the kind “B”, the contractor having the contractor ID “1” is selected from the seller list 504. This results in retrieval of information about the contractor having the contractor ID “1” from the contractor table 505, thereby to accomplish the purchase order for materials of the kind “B”. On the other hand, to make an order for a regenerating process on materials of the kind “B”, the contractor having the contractor ID “2” or the contractor having the contractor ID “3” is selected from the regeneration contractor list 506. This results in retrieval of information about the contractor having the contractor ID “2” or “3” from the contractor table 505, thereby to accomplish the order for a regenerating process on materials of the kind “B”.

Also, in a case where new materials of the kind “B” are purchased, a quantity of the new materials as ordered is added to a total quantity of materials of the kind “B” in stock which is stored in the stock table 400 upon arrival of the new materials as ordered. The total quantity of the materials of the kind “B” in stock is increased to a quantity equal to the total quantity of the materials in stock before arrival of the new materials plus the quantity of the new materials. On the other hand, in a case where an order for a regenerating process on materials of the kind “B” is made, a quantity of materials to be released for a regenerating process is subtracted from a total quantity of the materials of the kind “B” in stock which is stored in the stock table 400 when the order for a regenerating process is made. The total quantity of the materials of the kind “B” in stock is reduced to a quantity equal to the total quantity of the materials in stock before the order for a regenerating process minus the quantity of the materials to be released for a regenerating process. Further, when the materials are returned, having been regenerated, the quantity of the materials to be released for a regenerating process are added to the total quantity of the materials of the kind “B” in stock. Accordingly, the total quantity of the materials of the kind “B” in stock is increased to a quantity equal to the total quantity of the materials in stock before arrival of the regenerated materials and the quantity of the materials to be released out of a stock to be regenerated. Thus, in the case where an order for a regenerating process is made, not only addition but also subtraction, i.e., subtraction of a quantity of materials to be released for a regenerating process from a total quantity of the materials in stock, through interaction between the stock control section and the order control section. As described above, according to the first preferred embodiment, a quantity of materials in stock is controlled taking into account a quantity of materials to be released out of a stock for a regeneration process. Hence, the material control system according to the first preferred embodiment can effectively be applied to a stock control in which simply a gross quantity of materials released out of a stock to be regenerated and a gross quantity of materials in stock are controlled without identifying materials one by one using serial numbers.

In summary, according to the first preferred embodiment, the material control system includes the master table having the entry fields of the regeneration control flag 104 and the regeneration order control flag 201, the order control section for controlling a purchase order for, as well as an order for a regenerating process on, regeneratable materials, by using the regeneration order control flag 201, and the stock control section 201 for controlling a stock of materials, and the order control section and the stock control section are controlled in a centralized manner. This provides for centralized control of a stock and an order so as to keep an appropriate quantity of materials in stock, without differentiating a material which requires a regenerating process and a material which does not require a regenerating process. In particular, the material control system according to the first preferred embodiment controls both sellers and regeneration contractors for the same material kind, so that also procedures for making an order for a regenerating process can be accomplished.

Additionally, a quartz bulb employed in a diffusion furnace, an electrode of an etching apparatus, a pump and the like are examples of a material used during manufacture of semiconductor devices, which must be controlled while differentiating a seller and a regeneration contractor from each other, such as the material of the kind “B” as described above. The above-cited substances are likely to suffer abrasion of a surface thereof or degradation, and thus require a regenerating process for exposing a new surface by using chemicals or physically shaving the surface. In controlling regeneration contractors who undertake a regenerating process, it is necessary to take into account various problems. That is, a unit price to pay for one same material kind is different between a purchase order and an order for a regenerating process, and a plurality of regeneration contractors who specialize in a regenerating process and do not sell materials are registered. The material control system according to the first preferred embodiment deals with a material which requires a regenerating process and a material which does not require a regenerating process in a centralized manner while taking into account the foregoing problems.

Second Preferred Embodiment

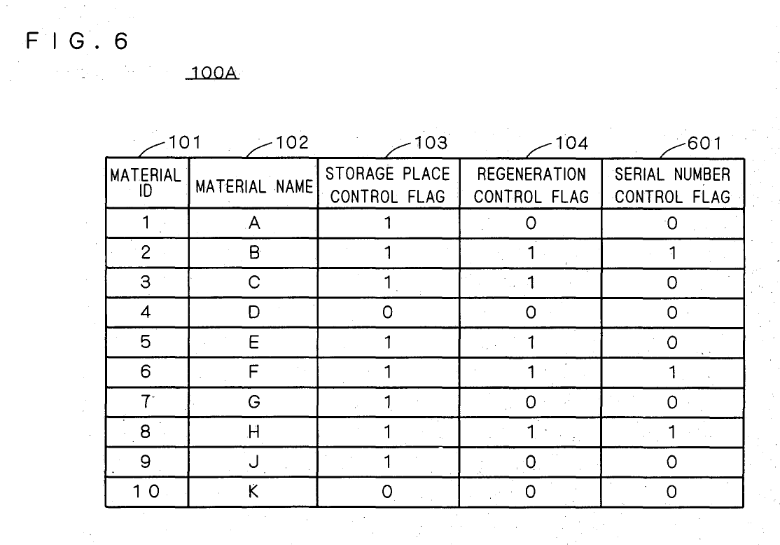

In an analogous manner to the material control system according to the first preferred embodiment, a material control system according to a second preferred embodiment provides for centralized control of a stock and an order on a manufacturing line for semiconductor devices or the like. The material control system includes a master table storing information for controlling materials one by one. FIG. 6 shows one example of a part of the master table of the material control system according to the second preferred embodiment. The part of the master table as illustrated in FIG. 6 will be hereinafter referred to as a “material master table 100A”. The material master table 100A is identical to the material master table 100 except that control information provided in an entry field of a serial number control flag 601 is additionally stored.

A serial number is an identification number assigned to each of individual materials, irrespective of kind. The serial number control flag 601 is a flag indicating whether or not a material is identified by its serial number to be controlled. In the example of FIG. 6, when a flag is “0”, it indicates “OFF”, while when a flag is “1”, it indicates “ON”. Thus, in FIG. 6, the serial number control flag 601 for each of the material kinds “B”, “F” and “H” is “ON”, which indicates that materials of the material kinds “B”, “F” and “H” are controlled on per-serial-number basis (in other words, each material of the kinds “B”, “F” and “H” is identified by its serial number to be controlled). Inclusion of the serial number control flag 601 makes it possible to uniformly control materials which are identified one by one and materials which are not identified one by one. It is noted that the material control system according to the second preferred embodiment employs the contractor master table 200 illustrated in FIG. 2 which is also employed in the material control system of the first preferred embodiment. Thus, a detailed description of the contractor master table 200 will be omitted in the second preferred embodiment.

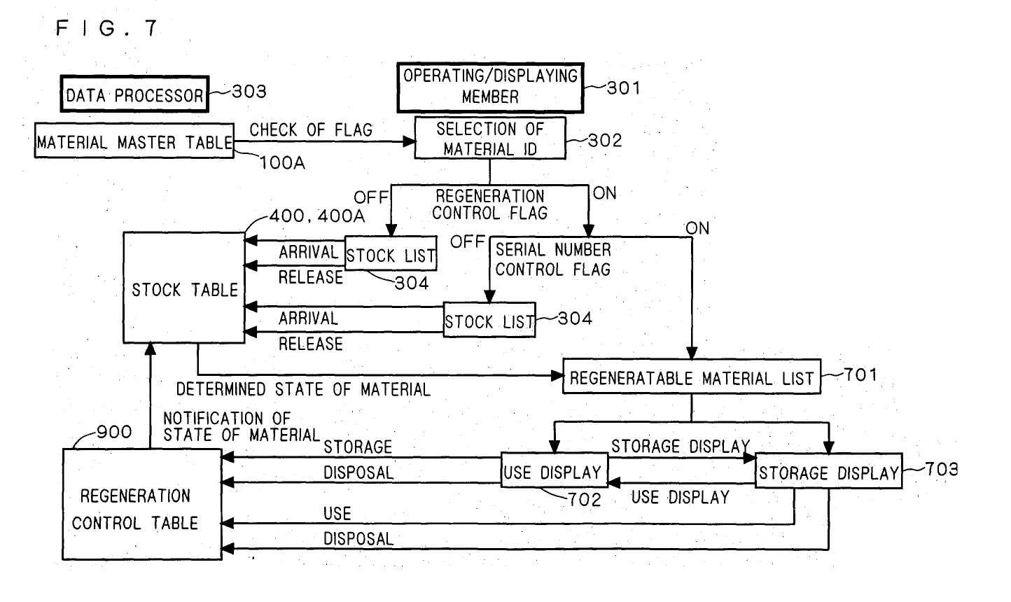

FIG. 7 is a part of a flow chart illustrating operations of the material control system according to the second preferred embodiment. The part of the flow chart of FIG. 7 is directed to operations of a stock control section of the material control system. First, upon the selection 302 of one material ID which is carried by the operating/displaying member 301, the data processor 303 consults the material master table 100A to check the regeneration control flag 104 for the selected material ID. For example, referring to FIGS. 2 and 6, when the material ID “4” in the field of the material ID 101 is selected, it is determined that a material of the kind having the material ID “4” is not regeneratable, from the regeneration control flag 104 therefor which is “OFF”, as a result of consultation of the material master table 100A of FIG. 6. Also, when the material ID “6” in the field of the material ID 101 is selected, it is determined that a material of the kind having the material ID “6” is regeneratable, from the regeneration control flag 104 therefor which is “ON”, in the same manner.

Next, if the regeneration control flag 104 for the selected material ID is “OFF”, the stock list 304 is displayed. Then, the stock list 304 is consulted, to control supply and/or release of materials of the kind having the selected material ID. Data for controlling supply and/or release is stored in the stock table 400 illustrated in FIG. 4 according to the first preferred embodiment. As described above, the stock table 400 stores information provided in the respective entry fields of the material ID 101, the storage place ID 401 and the stock quantity 402. In the example of FIG. 4, with respect to material kind having the material ID “4”, seventy-five pieces are in stock. The storage place ID 401 for the material kind having the material ID “4” is displayed as “0” for the same reasons as described in the first preferred embodiment. In the second preferred embodiment, even with “ON” of the regeneration control flag 104 for a given material ID, the stock list 304 is displayed if the serial number control flag 601 for the given material ID is “OFF”. For example, when the material ID “3” in the field of the material ID 101 of the material master table 100A illustrated in FIG. 6 is selected, the stock list 304 is displayed, which shows that five pieces are in stock at a storage place “5” as illustrated in FIG. 4.

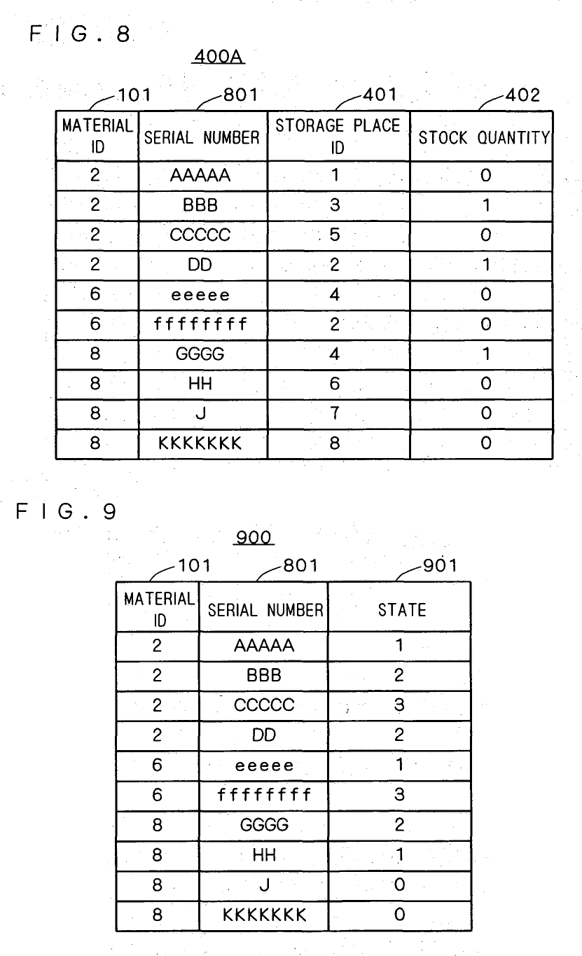

If each of the regeneration control flag 104 and the serial number control flag 601 for the selected material ID is “ON”, a list 701 of regeneratable materials (not shown and hereinafter referred to as a “regeneratable material list 701”) is displayed. In the regeneratable material list 701, regeneratable materials are displayed in a list form on a per-serial-number basis, based on determined states of materials shown in a stock table 400A according to the second preferred embodiment. FIG. 8 shows one example of the stock table 400A which further includes an entry field of a serial number 801, as compared to the stock table 400. Accordingly, the stock table 400A provides for stock control on a per-serial-number basis. Further, by dealing with information stored in the fields of the material ID 101 and the serial number 801 of the stock table 400A for each material in a unified manner, as a unique data, it is possible to trace a history of states of each material. In other words, it is possible to ensure traceability of each material. Additionally, as stock control is carried out on a material-by-material basis, a value to be stored in the field of the stock quantity 402 in the stock table 400A is either “1” or “0”.

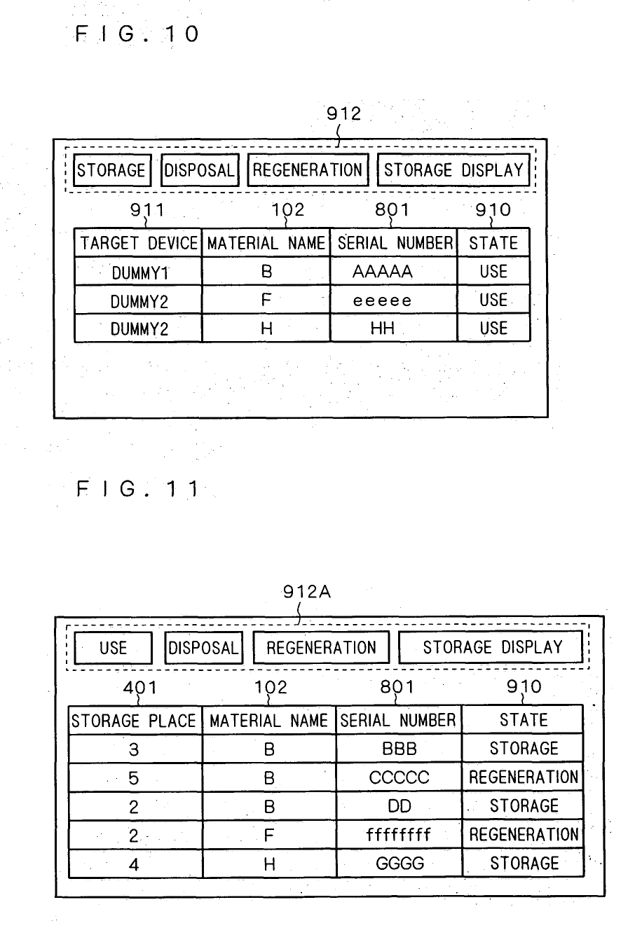

The stock table 400A is notified of respective states of materials by a regeneration control table 900, and in turn notifies the regeneratable material list 701 of respective determined states of the materials. FIG. 9 shows one example of the regeneration control table 900. Specifically, the regeneration control table 900 stores information provided in entry fields of the material ID 101, the serial number 801 and a state 901. In the field of the state 901, Arabic numbers each indicating a specific state of a material are stored. In the example of FIG. 9, “1”, “2”, “3” and “0”, indicate “use”, “storage”, “regeneration” and “disposal”, respectively. More specifically: “use” means that a material is released out of a stock to be attached to a target device and is being used; “storage” means that a material which has been attached to a target device is taken out from the target device and is being stored at a storage place; “regeneration” means that a material is being released out of a stock to be regenerated; and “disposal” means that a material is to be disposed of. If “disposal”, i.e., “0”, is displayed as a state for a given regeneratable material, it means that the material can be neither used nor regenerated.

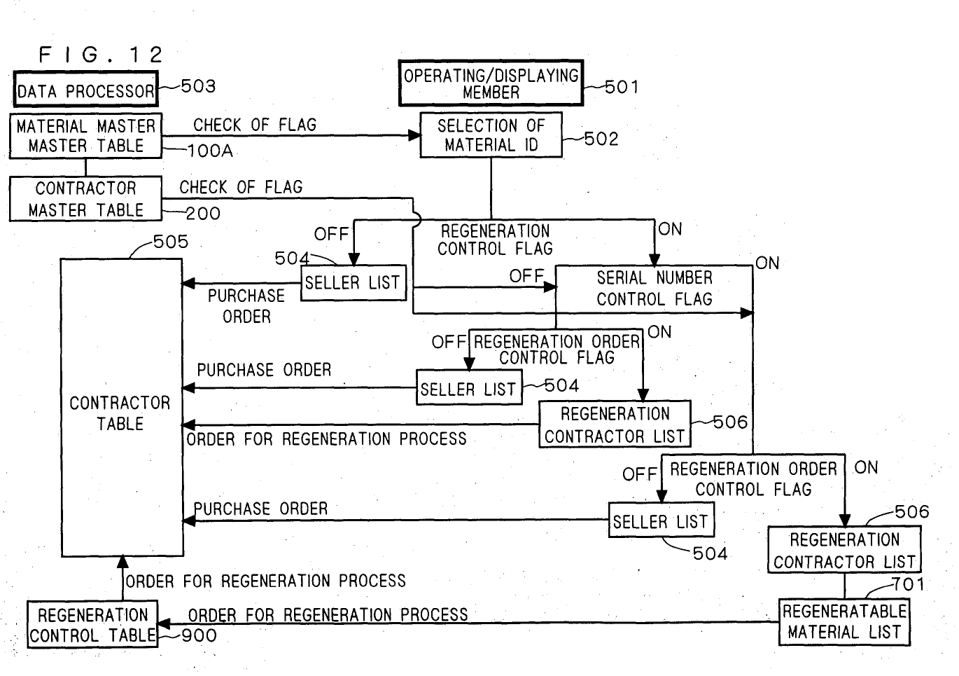

The regeneratable material list 701 according to the second preferred embodiment is provided with a use display 702 and a storage display 703. FIG. 10 shows one example of the use display 702. As illustrated in FIG. 10, information about materials being used is displayed on a per-serial-number basis in the use display 702. The use display 702 includes entry fields of the material name 102, the serial number 801, a state 910 and a target device 911. The use display 702 further includes an operation button area 912 for performing respective procedures for storage, disposal and regeneration. The operation button area 912 includes respective buttons, “STORAGE”, “DISPOSAL” and “REGENERATION” for initiating the above procedures, and further includes a button, “STORAGE DISPLAY” for switching to the storage display 703. FIG. 11 shows one example of the storage display 703. As illustrated in FIG. 11, information about materials being stored is displayed on a per-serial-number basis in the storage display 703. The storage display 703 includes entry fields of the material name 102, the serial number 801, the state 910 and the storage place 401. The storage display 703 further includes an operation button area 912A for performing respective procedures for use, disposal and regeneration. The operation button area 912A includes respective buttons, “USE”, “DISPOSAL” and “REGENERATION” for initiating the above procedures, and further includes a button, “USE DISPLAY” for switching to the use display 702.

Below, operations concerning the regeneratable material list 701 will be described by way of specific examples. First, operations performed when the use display 702 of the regeneratable material list 701 is activated will be described. According to a first specific example, assuming that the use display 702 shows information as provided in FIG. 10, a material of the kind “B” having a serial number “AAAAA” is selected and the button, “STORAGE” in the operation button area 912 is pressed. As a result, the state 901 for the material of the kind “B” having the serial number “AAAAA” stored in the regeneration control table 900 is changed. In the example of FIG. 9, “1” which has been shown as the state 901 for the material of the kind “B” having the serial number “AAAAA”, indicating that the material is being used, is changed to “2” indicating that the material is being stored. Then, the stock table 400A is notified of this change of the state 901 for the material having the serial number “AAAAA”. Upon notification of the change of the state 901, the stock table 400A updates the storage place ID 401 for the material of the kind “B” (of which material ID is “2”) having the serial number “AAAAA”, and changes the stock quantity 402 for the corresponding material from “0” to “1”. Then, the regeneratable material list 701 is notified of the foregoing changes in the regeneration control table 900 and the stock table 400A, as a determined state of the material of the kind “B” having the serial number “AAAAA”. This is followed by removal of information about the material of the kind “B” having the serial number “AAAAA” from the use display 702, and addition of the information about the material of the kind “B” having the serial number “AAAAA”, to the storage display 703, where “STORAGE” is shown as the state 910 for the corresponding material.

According to a second specific example, also assuming that the use display 702 shows information as provided in FIG. 10, a material of the kind “F” having a serial number “eeeee” is selected and the button, “DISPOSAL” in the operation button area 912 is pressed. As a result, the state 901 for the material of the kind “F” having the serial number “eeeee” stored in the regeneration control table 900 is changed. In the example of FIG. 9, “1” which has been shown as the state 901 for the material of the kind “F” having the serial number “eeeee”, indicating that the material is being used, is changed to “0” indicating that the material is to be disposed of Then, the stock table 400A is notified of this change of the state 901 for the material having the serial number “eeeee”. Upon notification of the change of the state 901, the stock table 400A updates the storage place ID 401 for the material of the kind “F” (of which material ID is “6”) having the serial number “eeeee”, and maintains “0” as the stock quantity 402 for the corresponding material unchanged. Then, the regeneratable material list 701 is notified of the foregoing changes in the regeneration control table 900 and the stock table 400A, as a determined state of the material of the kind “F” having the serial number “eeeee”. This is followed by removal of information about the material of the kind “F” having the serial number “eeeee” from the use display 702. The information about the material “F” having the serial number “eeeee” stored in the regeneration control table 900 and the stock table 400A is maintained after disposal of the corresponding material, in order to prevent the serial number “eeeee” from being assigned to a newly-arrived material of the kind “F”.

According to a third specific example, also assuming that the use display 702 shows information as provided in FIG. 10, a material “H” having a serial number “HH” is selected and the button, “REGENERATION” in the operation button area 912 is pressed. As a result, the state 901 for the material of the kind “H” having the serial number “HH” stored in the regeneration control table 900 is changed. In the example of FIG. 9, “1” which has been shown as the state 901 for the material of the kind “H” having the serial number “HH”, indicating that the material is being used, is changed to “3” indicating that the material is released out of a stock to be regenerated. Then, the stock table 400A is notified of this change of the state 901 for the material having the serial number “HH”. The stock table 400A, having been notified of the change of the state 901, updates the storage place 401 for the material of the kind “H” (of which material ID is “8”) having the serial number “HH” and maintains “0” as the stock quantity 402 for the corresponding material unchanged. Then, the regeneratable material list 701 is notified of the foregoing changes in the regeneration control table 900 and in the stock table 400A, as a determined state of the material of the kind “H” having the serial number “HH”. This is followed by removal of information about the material of the kind “H” having the serial number “HH” from the use display 702, and addition of the information about the material “H” having the serial number “HH” to the storage display 703, where “REGENERATION” is shown as the state 910 for the corresponding material.

Next, operations concerning the regeneratable material list 701 performed when the storage display 703 is activated will be described by way of a specific example. Assuming that the storage display 703 shows information as provided in FIG. 11, a material of the kind “B” having a serial number “BBB” is selected and the button, “USE” in the operation button area 912A is pressed. As a result, the state 901 for the material of the kind “B” having the serial number “BBB” stored in the regeneration control table 900 is changed. In the example illustrated in FIG. 9, “2” which has been shown as the state 901 for the material of the kind “B” having the serial number “BBB”, indicating that the material is being stored, is changed to “1” indicating that the material is being used. Then, the stock table 400A is notified of this change of the state 901 for the material of the kind “B” having the serial number “BBB”. Upon notification of the change of the state 901, the stock table 400A updates the storage place ID 401 for the material of the kind “B” (of which material ID is “2”), having the serial number “BBB” and changes the stock quantity 402 for the corresponding material from “1” to “0”. Then, the regeneratable material list 701 is notified of the foregoing changes in the regeneration control table 900 and the stock table 400A, as a determined state of the material of the kind “B” having the serial number “BBB”. This is followed by removal of information about the material of the kind “B” having the serial number “BBB” from the storage display 703, and addition of the information about the material of the kind “B” having the serial number “BBB” to the use display 702, where it is shown that the corresponding material is being used in the field of the state 910. Operations performed when a material having been stored is released out of a stock to be disposed of, or regenerated, are substantially similar to the operations described above regarding the use display 702.

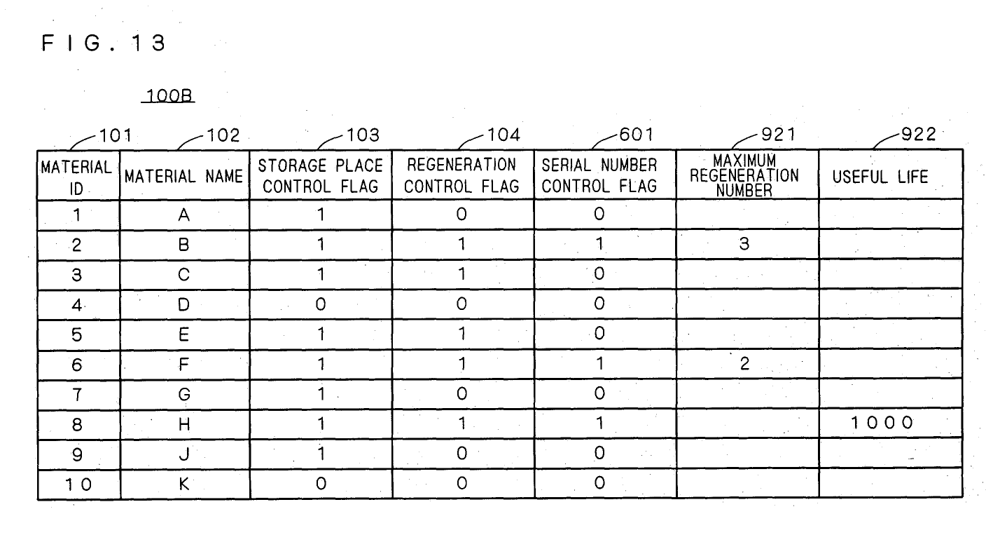

FIG. 12 is another part of the flow chart illustrating the operations of the material control system according to the second preferred embodiment. The part of the flow chart of FIG. 12 is directed to operations of an order control section of the material control system. First, upon the selection 502 of one material ID 101 which is carried by the operating/displaying member 501, the data processor 503 consults the material master table 100A to check the regeneration control flag 104 for the selected material ID. If the regeneration control flag 104 for the selected material ID is “OFF”, the seller list 504 is displayed. One seller in the seller list 504 is selected, and then a purchase order for materials having the selected material ID is given to one of contractors stored in the contractor table 505, who corresponds to the selected seller in the seller list 504. To this end, the contractor table 505 is consulted for information about the selected seller using the contractor ID 202 stored in the contractor master table 200.

If the regeneration control flag 104 for the selected material ID is “ON”, the data processor 503 consults the material master table 100A to check the serial number control flag 601 for the selected material ID. If the serial number control flag 601 for the selected material ID is “OFF”, the data processor 503 further consults the contractor master table 200 to check the regeneration order control flag 201. Then, if “OFF” is displayed as the regeneration order control flag 201 for the selected material ID, the seller list 504 is displayed. One seller in the seller list 504 is selected, and then a purchase order for materials having the selected material ID is given to one of contractors stored in the contractor table 505, who corresponds to the selected seller in the seller list 504. If “ON” is displayed as the regeneration order control flag 201 for the selected material ID, the regeneration contractor list 506 is displayed. One regeneration contractor included in the regeneration contractor list 506 is selected, to make an order for a regenerating process to one of the contractors stored in the contractor table 505, who corresponds to the selected regeneration contractor in the regeneration contractor list 506. To this end, the contractor table 505 is consulted for information about the selected regeneration contractor using the contractor ID 202 stored in the contractor master table 200.

If the serial number control flag 601 for the selected material ID is “ON”, the data processor 503 further consults the contractor master table 200 to check the regeneration order control flag 201 for the selected material ID. Then, if “OFF” is displayed as the regeneration order control flag 201 for the selected material ID, the seller list 504 is displayed. One seller in the seller list 504 is selected, and then a purchase order for materials having the selected material ID is given to one of contractors stored in the contractor table 505, who corresponds to the selected seller in the seller list 504. To this end, the contractor table 505 is consulted for information about the selected seller using the contractor ID 202 stored in the contractor master table 200. If “ON” is displayed as the regeneration order control flag 201 for the selected material ID, the regeneration contractor list 506 is displayed. As the serial number control flag 601 for the selected material ID is “ON”, a necessary procedure for releasing to regenerate one material having the selected material ID is carried out based on the regeneratable material list 701 which includes information about regeneratable materials one by one.

More specifically, a material which requires a regenerating process is selected based on the use display 702 or the storage display 703, and a necessary procedure for the regeneration process on the selected material is carried out. A suitable regeneration contractor to undertake the regeneration process on the selected material can be selected from the registered regeneration contractors in the regeneration contractor list 506. Then, an order for the regenerating process is made to one of the contractors registered in the contractor table 505, who corresponds to the selected regeneration contractors in the regeneration contractor list 506, through change of information in the regeneration control table 900. Information about the registered regeneration contractors is stored in the contractor table 505 which is consulted using the contractor ID 202 stored in the contractor master table 200.

For example, referring to FIGS. 6 and 10, in a case where the selected material ID is the material ID “2” of which kind is “B”, each of the regeneration control flag 104 and the serial number control flag 601 for the material kind “B” in the material master table 100A is “ON”. Then, if “OFF” is shown as the regeneration order control flag 201 for the material of the kind “B” in the contractor master table 200, the seller list 504 is displayed. For example, a seller having a contractor ID “1” is shown as a suitable contractor, together with its unit price “1,000,000” in the seller list 504. If “ON” is displayed as the regeneration order control flag 201 for the material kind “B”, the use display 702 or the storage display 703 is activated, which should show information about a material(s) of the kind “B” on a per-serial-number basis. Then, only when a material which requires a regenerating process is selected based on the display 702 or 703 and the operation button, “REGENERATION” is pressed, the regeneration contractor list 506 is displayed. For example, when a material of the kind “B” having a serial number “AAAAA” in the use display 702 illustrated in FIG. 10 is selected and the button, “REGENERATION” in the operation button area 912 is pressed, the regeneration contractor list 506 is displayed. For example, a contractor having a contractor ID “2” and a contractor having a contractor ID “3” are displayed as suitable contractors in the regeneration contractor list 506, together with respective unit prices “100,000” and “50,000”. If the contractor having the contractor ID “2” is selected, information about the contractor having the contractor ID “2” is obtained by consulting the contractor table 505 through the regeneration control table 900, thereby to make an order for a regenerating process on the material of the kind “B” having the serial number As described above, the material control system according to the second preferred embodiment includes the material master table 100A which additionally includes the entry field of the serial number control flag 601 for identifying materials individually, irrespective of kind. Then, the order control section controls an order for a regenerating process on materials on per-serial-number basis, and the stock control section controls a stock on a per-serial-number basis. This makes it possible to; control a stock and an order in a centralized manner so as to keep an appropriate quantity of materials in stock without differentiating a material which requires a regenerating process and a material which does not require a regenerating process; carry out procedures for use, storage, disposal and regeneration; control materials one by one; and store a history of states of each material, which ensures a traceability of each material.

Moreover, the material control system according to the second preferred embodiment includes the use display 702 and the storage display 703. The use display 702 shows information of materials being used on a per-serial-number basis and is capable of operating the stock control section or the order control section. The storage display 703 shows information of materials being in stock on a per-serial-number basis and is capable of operating the stock control section and the order control section. The use display 702 and the storage display 703 can be switched therebetween. As a result, a state of a stock and information about orders can be easily obtained, thereby to appropriately and effectively deal with materials.

Third Preferred Embodiment

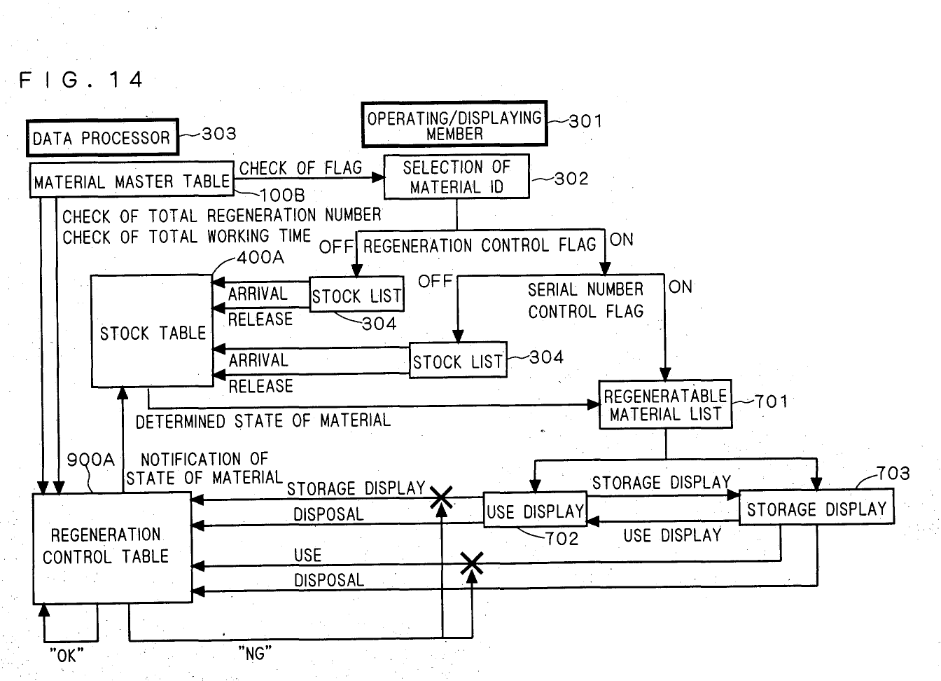

In an analogous manner to the material control system according to the first or second preferred embodiment, a material control system according to a third preferred embodiment provides for centralized control of a stock and an order on a manufacturing line for semiconductor devices or the like. The material control system includes a master table storing information for controlling materials one by one. FIG. 13 shows one example of a part of the master table of the material control system according to the third preferred embodiment, which will be hereinafter referred to as a “material master table 100B”. The material master table 100B as illustrated in FIG. 13 is identical to the material master table 100A except that control information provided in entry fields of a maximum regeneration number 921 and a useful life 922 are additionally stored. Each of the maximum regeneration number 921 and the useful life 922 is a threshold value defining a constraint on a regenerating process to be performed on each regeneratable material. In the material control system according to the third preferred embodiment, regeneratable materials are also controlled so as to satisfy the constraint on a regenerating process, based on the threshold value.

The maximum regeneration number 921 is a cumulative total number of times a regeneratable material can be regenerated. There is a limit to the number of times of regeneration of each regeneratable material. More specifically, after one regeneratable material is subjected to a regenerating process a certain number of times, the material can no longer be returned to a state to be provided before use, even if a further regenerating process is carried out on the material. The useful life 922 is a cumulative length of a time period during which a material can be used. More specifically, the useful life 922 is a cumulative length of time periods each from a time when one material starts to be used to a time when the material is stored or released to be regenerated. A time period during which a material is stored or released to be regenerated is not counted. The entry field of the useful life 922 is applied to a material which is degraded in quality thereof by use in nature. It is preferable to impose such a constraint on a regenerating process in controlling regeneratable materials, because to use a regeneratable material, of which the maximum regeneration time or useful life is reached, during manufacture of a product, would adversely affect the product to be manufactured to a great extent, so that a sufficient quality of the product to be manufactured can not be ensured.

In the example of FIG. 13, the maximum regeneration number 921 for the material kinds “B” and “F” are shown as three times and twice, respectively, while the useful life 922 for the material kind “H” is shown as “1,000 hours”. The maximum regeneration number 921 and the useful life 922 for the material kinds “C” and “E”, the regeneration control flag 104 for which is “ON”, are not set. This is because a serial number is not assigned to materials of the kinds “C” and “E” so that the materials of the kinds “C” and “E” can not be identified on a material-by-material basis. Accordingly, the materials of the kinds “C” and “E” are not controlled with respect to the number of times of regeneration or a time period of use. It is additionally noted that the material control system according to the third preferred embodiment employs the contractor master table 200 illustrated in FIG. 2 which is also employed in the material control systems of the first preferred embodiment. Thus, a detailed description of the contractor master table 200 will be omitted in the third preferred embodiment.

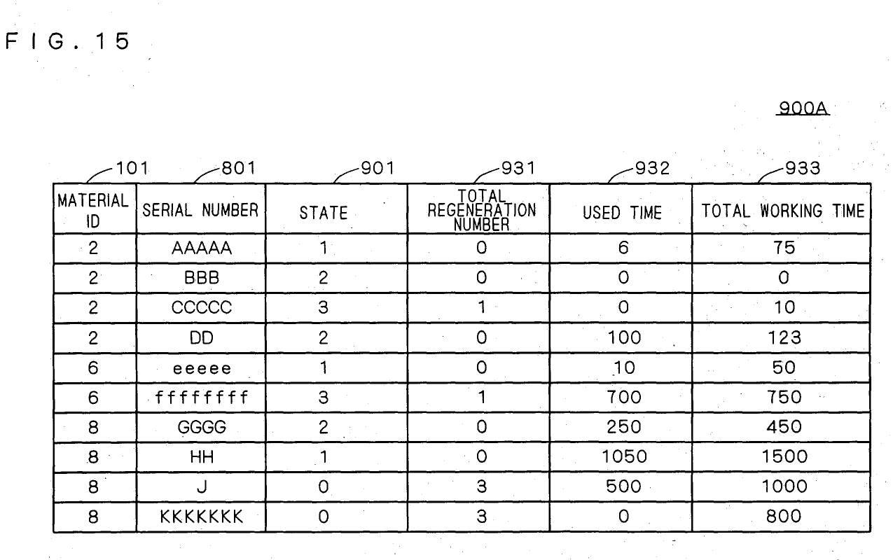

FIG. 14 is a part of a flow chart illustrating operations of the material control system according to the third preferred embodiment. The part of the flow chart of FIG. 14 is directed to operations of a stock control section of the material control system. First, upon the selection 302 of one material ID which is carried by the operating/displaying member 301, the data processor 303 consults the material master table 100B to check the regeneration control flag 104 for the selected material ID. If the regeneration control flag 104 for the selected material ID is “OFF”, the stock list 304 is displayed. On the other hand, if the regeneration control flag 104 for the selected material ID is “ON”, the data processor 303 consults the material master table 100B to check the serial number control flag 601. If the serial number control flag 601 for the selected material ID is “OFF”, the stock list 304 is displayed. On the other hand, if the serial number control flag 601 for the selected material ID is “ON”, the regeneratable material list 701 is displayed. The regeneratable material list 701 is provided with the use display 702 and the storage display 703.

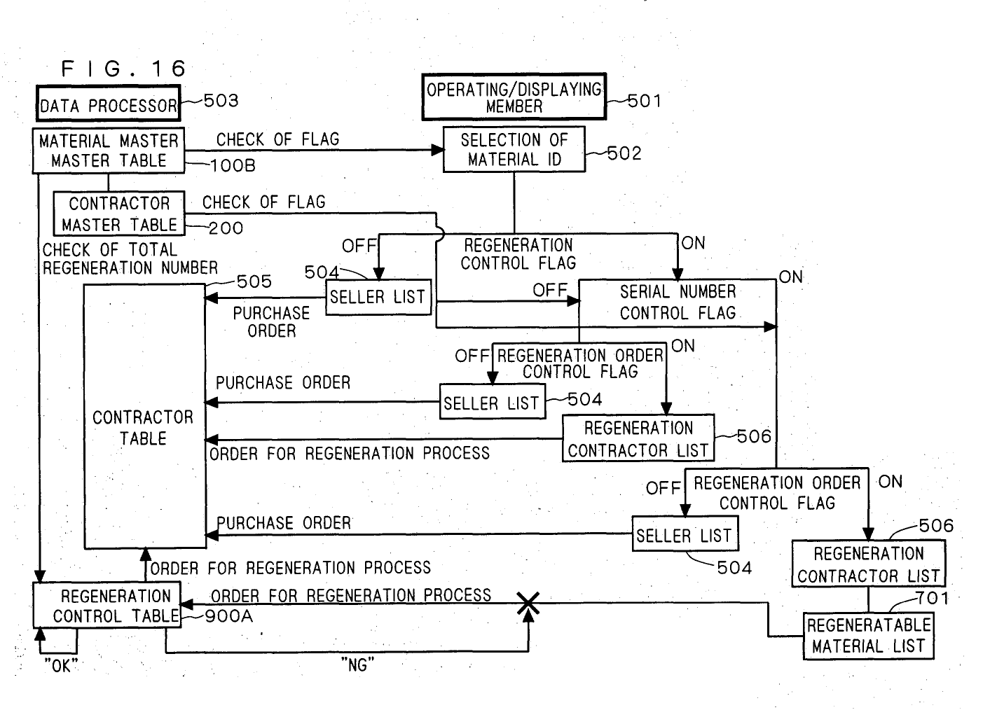

Information included in the use display 702 and the storage display 703 are based on respective determined states of materials which are notified by a regeneration control table 900A, through the stock table 400A illustrated in FIG. 8 according to the second preferred embodiment. The regeneration control table 900A according to the third preferred embodiment is different from the regeneration control table 900 according to the second preferred embodiment in that it includes entry fields of a total regeneration number 931, a working time 932 and a total working time 933, in addition to the entry fields of the material ID 101, the serial number 801 and the state 901. FIG. 15 shows an example of the regeneration control table 900A according to the third preferred embodiment. The fields of the total regeneration number 931, the working time 932 and the total working time 933 are included in order to control regeneratable materials so as to keep the number of times of regeneration and a time period of use thereof below the maximum regeneration number 921 and the useful life 922, respectively, stored in the material master table 100B.

The total regeneration number 931 is a cumulative total number of times a regeneratable material has been regenerated. The working time 932 is a time period from a time when a newly purchased material or a newly regenerated material is attached to a target device to a time when a state of the material is most recently stored/updated as “2 (storage)” or “3 (regeneration)” in the regeneration control table 900A. The total working time 933 is a cumulative sum of a time period from a material is newly purchased to a time when a state of the material is most recently stored/updated as “2 (storage)” or “3 (regeneration)” in the regeneration control table 900A.

Below, how a regeneratable material is controlled so as to satisfy a constraint on a regenerating process thereof will be described by way of a specific example. First, assuming that the use display 702 shows information as provided in FIG. 10, a material of the kind “B” having a serial number “AAAAA” is selected and the button, “STORAGE” in the operation button area 912 is pressed. As a result, a check as to whether or not the total regeneration number 931 of the selected material is equal to or exceeds the maximum regeneration number 921 for the selected material stored in the material master table 100B is made. If the total regeneration number 931 of the selected material is below the maximum regeneration number 921 thereof, the state 901 for the selected material of the kind “B” having the serial number “AAAAA” in the regeneration control table 900A is changed. In the example of FIG. 15, “1” which has been shown as the state 901 for the material of the kind “B” having the serial number “AAAAA”, indicating that the material is being used, is changed to “2” indicating that the material is being stored. At that time, in the example of FIG. 15, the total regeneration number 931 of the material of the kind “B” having the serial number “AAAAA” is “0”, which is below the maximum regeneration number 921 of “3”, so that the material having the serial number “AAAAA” is determined as “OK”. After that, the same operations as described in the second preferred embodiment are carried out, a description of which is omitted in the third preferred embodiment. On the other hand, if the total regeneration number 931 of the selected material is equal to or exceeds the maximum regeneration number 921 so that the selected material is determined as “NG”; a message meaning that the selected material can no longer be regenerated is displayed. In such a situation, no other procedure than a procedure for disposal can be carried out. It is additionally noted that the use display 702 includes entry fields of the total regeneration number 931, the working time 932 and the total working time 933, in addition to the entry fields of the material name 102, the state 910 and the like, to allow a user to determine availability of each material, though such additional entry fields are not shown in FIG. 10.

Next, assuming that the storage display 703 shows information as provided in FIG. 11, a material of the kind “H” having a serial number “GGGG” is selected and the button, “USE” in the operation button area 912A is pressed. As a result, a check as to whether or not the total working time 933 of the selected material is equal to or exceeds the useful life 922 for the selected material stored in the material master table 100B is made. If the total working time 933 of the selected material is below the useful life 922 thereof, the state 901 for the selected material of the kind “H” having the serial number “GGGG” in the regeneration control table 900A is changed. In the example of FIG. 15, “2” which has been shown as the state 901 for the material having the serial number “GGGG”, indicating that the material is being stored, is changed to “1” indicating that the material is being used. At that time, in the example of FIG. 15, the total working time 933 of the material of the kind “H” having the serial number “GGGG” is “450 hours”, which is below the useful life 922 of “1,000 hours”, so that the material having the serial number “GGGG” is determined as “OK”. After that, the same operations as described in the second preferred embodiment are carried out, a description of which is omitted in the third preferred embodiment. Referring to FIG. 15, each of the working time 932 and the total working time 933 of the selected material of the kind “H” having the serial number “GGGG” starts to be counted at a time when the state 901 for the selected material is changed from storage (“2”) to use (“1”), and will be counted until the state 901 for the selected material is changed from use (“1”) to storage (“2”) or regeneration (“3”) in the regeneration control table 900A. On the other hand, if the total working time 933 of the selected material is equal to or exceeds the useful life 922 so that the selected material is determined as “NG”, a message meaning that the selected material can no longer be regenerated is displayed. In such a situation, no other procedure than a procedure for disposal can be carried out. It is additionally noted that the storage display 703 includes entry fields of the total regeneration number 931, the working time 932 and the total working time 933, in addition to the entry fields of the material name 102, the state 910 and the like, to allow a user to determine availability of each material, though such additional entry fields are not shown in FIG. 11.

FIG. 16 is another part of the flow chart illustrating the operations of the material control system according to the third preferred embodiment. The part of the flow chart of FIG. 16 is directed to operations of an order control section of the material control system. First, upon the selection 502 of one material ID 101 which is carried by the operating/displaying member 501, the data processor 503 consults the material master table 100B to check the regeneration control flag 104 for the selected material ID. If the regeneration control flag 104 for the selected material ID is “OFF”, the seller list 504 is displayed. On the other hand, if the regeneration control flag 104 for the selected material ID is “ON”, the data processor 503 consults the material master table 100B to check the serial number control flag 601. Then, if the serial number control flag 601 for the selected material ID is “OFF”, the data processor 503 further consults the contractor master table 200 to check the regeneration order control flag 201. If “OFF” is displayed as the regeneration order control flag 201 for the selected material ID, the seller list 504 is displayed. If “ON” is displayed as the regeneration order control flag 201 for the selected material ID, the regeneration contractor list 506 is displayed.

Further, if the serial number control flag 601 for the selected material ID is “ON”, the data processor 503 further consults the contractor master table 200 to check the regeneration order control flag 201. If “OFF” is displayed as the regeneration order control flag 201 for the selected material ID, the seller list 504 is displayed. If “ON” is displayed as the regeneration order control flag 201 for the selected material ID, the regeneration contractor list 506 is displayed. As the serial number control flag 601 for the selected material ID is “ON”, a necessary procedure for releasing to regenerate one material of the kind having the selected material ID is carried out based on the regeneratable material list 701 which includes information about regeneratable materials one by one.

More specifically, a procedure for releasing to regenerate one material is carried out by using the storage display 703, for example, as follows. Assuming that the storage display 703 shows information as provided in FIG. 11, a material of the kind “B” having a serial number “DD” is selected, and the button, “REGENERATION” in the operation button area 912A is pressed. As a result, a check as to whether or not the total regeneration number 931 of the selected material is equal to or exceeds the maximum regeneration number 921 of the selected material stored in the material master table 100B is made. If the total regeneration number 931 of the selected material is below the maximum regeneration number 921, the state 901 for the selected material stored in the regeneration control table 900A is changed from storage (“2”) to regeneration (“3”). At that time, in the example of FIG. 15, the total regeneration number 931 of the material of the kind “B” having the serial number “DD” is “0”, which is below the maximum regeneration number 921 of “3”, so that the material having the serial number “DD” is determined as “OK”. After that, the same operations as described in the second preferred embodiment are carried out, a description of which is omitted in the third preferred embodiment.

A procedure for releasing to regenerate one material is carried out in the same manner as described above also by using the use display 702. The above-description of the third preferred embodiment refers to a case where regeneratable materials are controlled with respect to only the number of times of regeneration using the maximum regeneration number 921 as a threshold value (the materials of the kinds “B” and “F”) or with respect to only a time period of use using the useful life 922 as a threshold value (the materials of the kind “H”). However, the present invention is not limited to such description, in which other threshold values such as a maximum number of times a material can be used, may be set for controlling materials. Also, in the present invention, materials may be controlled with respect to both the number of times of regeneration and a time period of use, in which case the materials are determined to be “NG” when either the maximum regeneration number 921 or the useful life 922 is reached.

As described above, the material control system according to the third preferred embodiment includes the material master table 100B which further includes an entry field of a threshold value defining a constraint on a regenerating process. Then, the order control section functions to stop an order for a regenerating process on a material if a value contained in information about regeneration of the material which is stored on a per-serial-number basis is equal to or exceeds the threshold value. Also, the stock control section functions to urge a material to be disposed of when a value contained in information about regeneration of the material is equal to or exceeds the threshold value. This makes it possible to control a stock and an order in a centralized manner so as to keep an appropriate quantity of materials in stock, without differentiating a material which requires a regenerating process and a material which does not require a regenerating process, and to control regeneratable materials so as to satisfy a constraint on a regenerating process. Accordingly, only proper materials are used for manufacture of semiconductor devices, thereby to ensure a quality of each product.

While the invention has been shown and described in detail, the foregoing description is in all aspects illustrative and not restrictive. It is therefore understood that numerous modifications and variations can be devised without departing from the scope of the invention.

What is claimed is:

1. A material control system comprising:
a master table including an entry field of a regeneration control flag indicating whether or not each of materials to be used in a manufacturing apparatus is regeneratable and an entry field of a regeneration order control flag indicating whether a registered contractor is a seller or a regeneration contractor, said master table storing information for controlling each of said materials;
an order control section for controlling a purchase order for, and an order for a regenerating process on, regeneratable materials out of said materials, using said regeneration order control flag: and
a stock control section for controlling a stock of said materials,
wherein said order control section and said stock control section are controlled in a centralized manner.

2. The material control system according to claim 1,
wherein said master table further includes an entry field of a serial number control flag for identifying each of said materials,
said order control section controls said order for a regenerating process on said regeneratable materials based on per-serial-number basis, and
said stock control section controls said stock of said materials on said per-serial-number basis.

3. The material control system according to claim 2,
wherein said master table further includes an entry field of a threshold value defining a constraint on a regenerating process on said regeneratable materials,
said order control section controls such that no order for a regenerating process is made when a value contained in information about each of said regeneratable materials becomes equal to or exceeds said threshold value, said information being stored on said per-serial-number basis, and
said stock control section urges each of said regeneratable materials to be disposed of when said value in said information about each of said regeneratable materials becomes equal to or exceeds said threshold value.

4. The material control system according to claim 3,
wherein said threshold value is a cumulative total number of regenerating processes.

5. The material control system according to claim 3,
wherein said threshold value is a cumulative sum of a time period of use.

6. The material control system according to claim 2, further comprising:
a use display for showing information of materials which are being used out of said materials on said per-serial-number basis and is capable of operating said order control section and said stock control section; and
a storage display for showing information of materials which are being stored out of said materials on said per-serial-number basis and is capable of operating said order control section and said stock control section,
wherein said use display and said storage display are switched therebetween.

7. The material control system according to claim 3, further comprising:
a use display for showing information of materials which are being used out of said materials on said per-serial-number basis and is capable of operating said order control section and said stock control section; and
a storage display for showing information of material which are being stored out of said materials on said per-serial-number basis and is capable of operating said order control section and
said stock control section,
wherein said use display and said storage display are switched therebetween.
